(19) United States
(12) Patent Application Publication
(10) Pub. No.: US 2005/0278376 A1
(43) Pub. Date: Dec. 15, 2005

(54) Media distribution system, device, and method

(75) Inventor: Luis J. Diaz, Green Brook, NJ (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: IDT Corporation

(21) Appl. No.: 10/867,166

(22) Filed: Jun. 14, 2004

(51) Int. Cl. G06F 17/00

(52) U.S. Cl. 707/104.1

(57) ABSTRACT

A machine-readable media device and a media distribution system are provided. The device has a first readable portion and a second readable portion. The first portion can initialize a license verification process to a remote location, while the second portion has media that can only be accessed only upon successful completion of the license verification process. The system includes a machine-readable media device, a unique identifier disposed on the machine-readable media device, and media disposed on the machine-readable media device. A machine reads the unique identifier and communicates the unique identifier to a remote server. The remote server authorizes the machine to access the media based on a comparison of the unique identifier to a database resident on the remote server.

### BACKGROUND OF THE INVENTION

1. Field of the Invention

The present disclosure relates to the distribution of media. More particularly, the present disclosure relates to systems, devices, and methods for distributing media.

2. Description of Related Art

The distribution of media (“media”) such as songs, movies, computer games, software, and other media to end-users is an important aspect of the consumer acceptance and commercial success of the distributed media.

Traditionally, media has been stored on a physical, machine-readable device such as, but not limited to, a compact disc (“CD”), a digital video disc (“DVD”), a digital mini disc, and other non-disc machine-readable devices. These physical media devices are then distributed to consumers through retail sales outlets or rental outlets. The sales and rental outlets can include physical stores, as well as virtual Internet stores. The retail distribution model gives the consumer an unlimited license to the valuable media stored on the physical device. Namely, the consumer can use the media an unlimited number of times. As such, the retail distribution model has led to a pricing structure that accounts for the unlimited license, which can make the pricing potentially cost prohibitive to the average consumer.

More recently, media has been distributed to the user as requested over networks, such as, but not limited to, the world wide web (i.e., Internet), cable networks, and satellite networks. Here, the media remains stored on the distributor's server and, thus the distributor retains a control over the media. The consumer can purchase a single use license for the media as desired. The media is then provided to the user over the network. Unfortunately, this streaming data distribution model does not enable sales of media at traditional retail outlets, which can limit the commercial appeal of this distribution method to many consumers. Also, the amount of data present in the media often makes transmission or streaming of data across networks slow and/or unreliable.

Disposable media devices are being developed to address the unlimited license aspects of the retail distribution model and the need for sales at traditional retail outlets of the streaming data distribution model. An exemplary disposable media device is a DVD that self-destructs forty-eight hours after the package is opened. Such disposable media devices are commercially available from Evatone of Clearwater, Fla. Unfortunately, this time-sensitive distribution model has not yet proven economically or ecologically viable.

Accordingly, it has been determined by the present disclosure that there is a need for methods, systems, and devices for distributing media that overcome one or more of the drawbacks and deficiencies of the prior distribution systems, methods, and devices.

### BRIEF SUMMARY OF THE INVENTION

A machine-readable media device is provided. The device includes a first readable portion and a second readable portion. The first portion can initialize a license verification process to a remote location. The second readable portion has a selected media that can only be accessed only upon successful completion of the license verification process.

A media distribution system is also provided. The system includes a machine-readable media device, a unique identifier disposed on the machine-readable media device, and media disposed on the machine-readable media device. A machine reads the unique identifier and communicates the unique identifier to a remote server. The remote server authorizes the machine to access the media based on a comparison of the unique identifier to a database resident on the remote server.

A method of distributing media is provided. The method includes storing the media on a machine-readable device; storing a unique identifier on the machine-readable device; associating the unique identifier with an account stored on a remote database; receiving the unique identifier in the remote database when the machine-readable device is read; and authorizing use of the media based on a comparison of a condition of the account to a predetermined condition.

In some embodiments, a rechargeable media account is provided. The account includes a value associated with one or more unique media identifiers. The value can be decreased when a user accesses a rechargeable media device identified by the unique media identifier. In addition, the value can be increased as needed by the user. In some embodiments, the rechargeable media account can include a plurality of unique media identifiers. Here, the value can be decreased when a user accesses media identified by any of the plurality of unique media identifiers.

The above-described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

FIG. 1 is a schematic depiction of an exemplary embodiment of a media distribution system; and

FIG. 2 is a schematic depiction of an exemplary embodiment of a rechargeable media device.

### DETAILED DESCRIPTION OF THE INVENTION

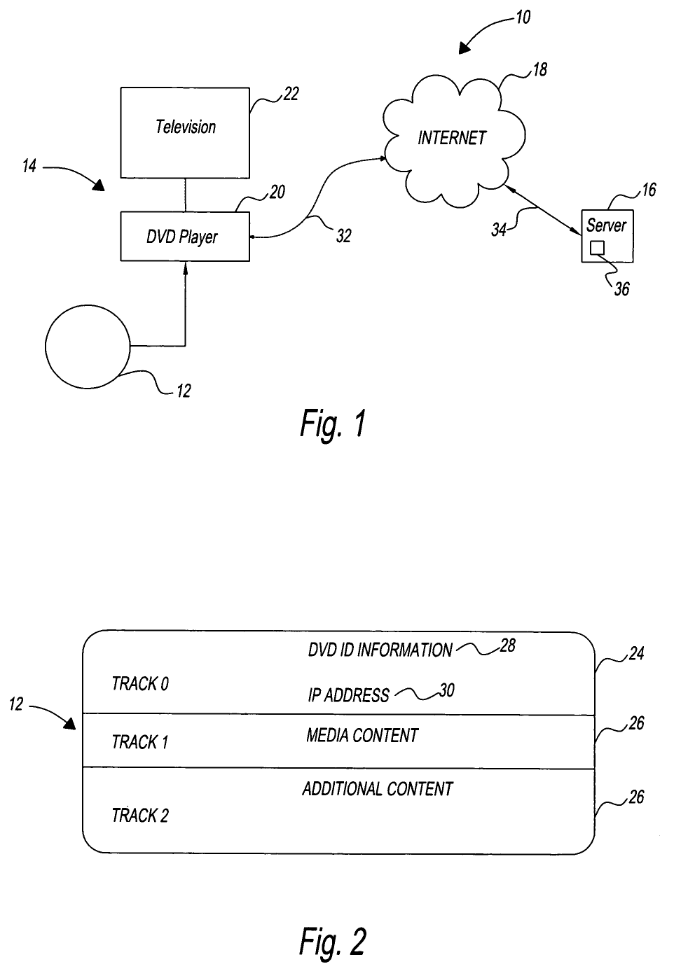

Referring to the drawings and in particular to FIG. 1, there is provided a media distribution system according to the present disclosure generally referred to by reference numeral 10. System 10 includes a rechargeable media device 12, an audio-visual device 14, and a server 16. In system 10, audio-visual device 14 is adapted to communicate with server 16 via a network 18, such as the Internet. Server 16 is positioned remote from audio-visual device 14. For example, server 16 can be located at a media distributor's facility, while audio-visual device 14 can be located at a consumer's home.

Advantageously, system 10 separates the number of plays from the physical disc by managing the use of rechargeable media device 12 at server 16. For example, rechargeable media device 12 is a limited use device. Namely, the use of rechargeable media device 12 is conditional on an authority message received from server 16 over network 18. In this manner, system 10 manages the number of “licenses to” or “uses of” the media on rechargeable media device 12 at a central location (i.e., server 16). This number of uses can be updated or recharged, as desired, by the consumer.

System 10 enables rechargeable media device 12 to be sold through traditional retail outlets (e.g., physical and virtual stores). Further, system 10 enables the price of rechargeable media device 12 to be based on a limited number of uses of the media. This allows rechargeable media device 12 to be priced similar to the pricing of the aforementioned time-sensitive devices. Also, since the media is resident on rechargeable media device 12, system 10 eliminates the need for streaming of data as in the streaming data distribution systems.

In the illustrated embodiment, rechargeable media device 12 is a DVD and audio-visual device 14 is a DVD player 20 in electrical communication with a television 22. DVD player 20 is an Internet capable device capable of communicating over network 18 (e.g., the Internet) with server 16. Internet capable DVD devices are commercially available from, for example, Gateway, Inc. under the “Connected” trade name. Thus, system 10 is configured to manage the use of rechargeable media device 12 at server 16 via network 18.

Referring now to FIG. 2, rechargeable media device 12 has a first portion 24 and one or more second portions 26. First portion 24 allows system 10 to verify the status of the license to the media. In an exemplary embodiment, first portion 24 includes a unique DVD identifier 28 and an address 30 to server 16. Second portions 26 include the selected media, such as, but not limited to, a movie, a song, a computer game, computer software, and the like.

The use of system 10 is described with simultaneous reference to FIGS. 1 and 2. To begin use, the consumer places rechargeable media device 12 in audio-visual device 14. Audio-visual device 14 begins by reading first portion 24. First portion 24 directs audio-visual device 14 to send a first message 32 to server 16. First message 32 is a request for the authority to access second portion 26. For example, first message 32 can be sent to server 16 located at address 30 and can include unique DVD identifier 28. Thus, system 10 is configured to request authority to access second portion 26 by sending unique DVD identifier 28 over network 18 to server 16 when the consumer attempts to access the media on rechargeable media device 12. Specifically, first portion 24 initializes a license verification process to server 16.

Server 16 determines the status of rechargeable media device 12 upon receipt of first message 32. Rechargeable media device 12 can have a first status indicative of an authority to access second portion 26 or a second status indicative of a denial to access the second portion. Server 16 returns a second message 34 to audio-visual device 14 indicative of this status. Audio-visual device 14 accesses or denies access to second portion 26 based upon second message 34.

In an exemplary embodiment, system 10 includes a database 36 resident on server 16. Database 36 can include an account for the particular rechargeable media device 12 represented by unique DVD identifier 28 present in first message 32. The account can be rechargeable, as desired, by the user. For example, the user can increase the monetary value or number of uses present in the account. In response to first message 32, server 16 determines whether the account associated with unique DVD identifier 28 has sufficient monetary value or number of uses to authorize the requested use of the rechargeable media device 12. When server 16 determines that the account has sufficient value or number of plays, the server sends second message 34 to audio-visual device 14 allowing access to second portion 26 and decrements the account a predetermined amount.

However, when server 16 determines that the account lacks sufficient value or number of plays, the server sends second message 34 to audio-visual device 14 denying access to second portion 26. In some embodiments where second message 34 denies access, the second message can prompt the user to purchase additional uses or value on an on-demand basis.

In this manner, system 10 allows second portion 26 to be accessed by the consumer only when authorized by server 16. Moreover, system 10 does not need to transmit the media present on rechargeable media device 12. Rather, system 10 merely transmits the request for authority and the acceptance or denial of such request between server 16 and audio-visual device 14.

Database 36 can operate in a one-to-one relational manner as discussed above. Namely, database 36 can associate unique DVD identifier 28 to an account particularly for that identifier (e.g., a dedicated account). Of course, it is also contemplated by the present invention for database 36 to operate in a one-to-many relational manner. Here, the user can create a universal account in database 36 and then can associate any number of unique DVD identifiers 28 to that universal account. In use of such a one-to-many database 36, first message 32 can further include the account number of the universal account. In both examples, the user can recharge the value or number of uses in their client, universal or dedicated, account on an as needed basis.

The universal account can be loaded or associated with any desired media at the time of purchase of rechargeable media device 12. In addition, the universal account can be loaded or associated with any desired media as needed, such as when a dedicated account for a particular rechargeable media device 12 has been exhausted. In some embodiments, the consumer can merge the value or number of plays resident in one or more dedicated accounts into the value resident in a universal account.

Advantageously, the systems, devices, and methods of the present disclosure allow the consumer to create a library of media less expensively than previously possible. For example, prior systems required the consumer to buy a DVD for $20 or rent the DVD for $5 per rental. In contrast, system 10 enables the consumer to buy rechargeable media device 12 having several initial uses for $5. Once the initial uses are spent, the consumer can recharge, as desired, the use of the media stored on the rechargeable media device on an as needed basis. Thus, system 10 provides the consumer with the ability to inexpensively create a library of works. This library can be created without the need for the infrastructure to receive large amounts of data as is required by the streaming data distribution model. Further, this library can be created without the need for the unlimited license pricing structure of the retail distribution model.

In some embodiments of system 10, the initial purchase of rechargeable media device 12 can include a pre-selected number of uses in the account for that particular rechargeable media device. In other embodiments of system 10, the consumer, at the time of purchase, can purchase any desired number of uses of the rechargeable media device 12. Here, the purchase price of the rechargeable media device 12 can be based on the number of uses desired.

In this manner, system 10 allows the user to create the dedicated account or universal account on server 16 at the time of purchase of rechargeable media device 12. Further, system 10 allows the user to create the dedicated account or universal account on server 16 at anytime after the purchase of rechargeable media device 12. Regardless of when the account is created, the value of the account can be increased or the number of plays in the account can be increased (“recharged”) as needed by, for example, a telephone transaction, an Internet transaction, and other transactional methods.

Accordingly, system 10 can include a rechargeable media account resident on server 16. The account can include a value associated with one or more unique DVD identifiers 28. The value can be decreased when a user accesses a rechargeable media device 12 identified by the unique DVD identifier 28. In addition, the value can be increased as needed by the user. In some embodiments, the rechargeable media account can include a plurality of unique DVD identifiers 28. Here, the value can be decreased when a user accesses a rechargeable media device 12 identified by any of the plurality of unique DVD identifiers 28. The value in the rechargeable media account according to the present disclosure can be a monetary value, a number of plays of the media, and the like.

In still other embodiments of system 10, the system can be configured to establish an upper purchase limit for a particular media. Here, the user would gain full, unlimited access to the media on rechargeable media device 12 after purchasing a predetermined number of uses. In this manner, system 10 can be configured to cap the consumer's maximum cost. Notwithstanding the users full, unlimited access to the media, system 10 would confirm its status each time rechargeable media device 12 is accessed.

For purposes of clarity, system 10 is illustrated having one audio-visual device 14 communicating with one server 16. Of course, it is contemplated by the present disclosure for system 10 to have any number of servers 16 communicating with any number of audio-visual devices 14. Further, it is contemplated by the present disclosure for network 18 to be a wired network, a wireless network, or any combinations thereof to provide communications between server 16 and audio-visual devices 14.

It should also be recognized that system 10 is illustrated by way of example as a DVD system. Of course, it is contemplated by the present disclosure system 10 to be other systems. For example, audio-visual device 14 can be a personal computer or a laptop computer capable of reading rechargeable media device 12 and communicating with server 16. Further, it is contemplated by the present disclosure for device 12 to be any physical, machine-readable device capable of storing the desired media. For example, media device 12 can be a DVD, CD, a digital minidisk, a digital tape, a memory stick, and other machine-readable devices.

It be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

1. A machine-readable media device comprising:
a first readable portion having means for initializing a license verification process to a remote location; and
a second readable portion having a selected media, said selected media being accessible only upon successful completion of said license verification process.

2. The device as in claim 1, wherein said first readable portion comprises a unique identifier and a network address to said remote location.

3. The device as in claim 2, wherein said first readable portion further comprises a client account number.

4. The device as in claim 3, wherein said client account number is associated with a dedicated account and/or a universal account.

5. The device as in claim 1, wherein said selected media comprises media selected from the group consisting of a movie, a song, a computer game, computer software, and any combinations thereof.

6. The device as in claim 1, wherein the device is a DVD, a CD, a digital minidisk, a digital tape, or a memory stick.

7. A media distribution system comprising
a machine-readable media device;
a unique identifier disposed on said machine-readable media device;
media disposed on said machine-readable media device;
a machine for reading said unique identifier and said media from said machine-readable media device; and
a remote server for communicating with said machine, said remote server authorizing said machine to access said media based on a comparison of said unique identifier to a database resident on said remote server.

8. The system as in claim 7, wherein said machine-readable media device is a device selected from the group consisting of a DVD, a CD, a digital minidisk, a digital tape, and a memory stick.

9. The system as in claim 7, wherein said machine-readable media device further comprises a network address for communicating with said remote server.

10. The system as in claim 9, wherein said machine-readable media device further comprises a client account number.

11. The system as in claim 7, wherein said media comprises media selected from the group consisting of a movie, a song, a computer game, computer software, and any combinations thereof.

12. The system as in claim 7, further comprising an account associated with said unique identifier, said account being resident on said database, said remote server authorizing said machine to access said media only when said account has a value more than a predetermined value.

13. The system as in claim 12, wherein said machine is configured to update said value.

14. The system as in claim 12, wherein said account is associated with unique identifiers of other machine-readable media devices.

15. The system as in claim 7, wherein said machine is a DVD player capable of communicating with said remote server via the Internet.

16. A method of distributing media, the method comprising:
storing the media on a machine-readable device;
storing a unique identifier on said machine-readable device;
associating said unique identifier with an account stored on a remote database;
receiving said unique identifier in said remote database when said machine-readable device is accessed; and
authorizing use of the media on said machine-readable device based on a comparison of a condition of said account to a predetermined condition.

17. The method as in claim 16, further comprising storing a network address to said database on said machine-readable device.

18. The method as in claim 16, wherein communicating said unique identifier to said database comprises sending a first message from a consumer device reading said machine-readable device to said database via the Internet.

19. The method as in claim 18, wherein authorizing use of the media comprises sending a second message from said database to said consumer device to via the Internet.

20. The method as in claim 16, wherein said condition of said account is a monetary value or a number of uses.

21. The method as in claim 16, further comprising adjusting said condition of said account.

22. The method as in claim 16, further comprising associating a plurality of unique identifiers with said account.

23. A rechargeable media account, comprising:
a value in the account; and
a unique media identifier associated with the account, wherein said value can be decreased when a user accesses media identified by said unique media identifier and can be increased as needed by the user.

24. The rechargeable media account as in claim 23, wherein said unique media identifier comprises a plurality of unique media identifiers, wherein said value can be decreased when a user accesses media identified by any of said plurality of unique media identifiers.

25. The rechargeable media account as in claim 23, wherein said value comprises a monetary value or a number or plays of the media.
